(19) United States
(12) Patent Application Publication
(10) Pub. No.: US 2018/0279629 A1
(43) Pub. Date: Oct. 4, 2018

(54) Pecan Lemon Meringue Pie

(71) Applicant: Edward Turner, Los Angeles, CA (US)

(72) Inventor: Edward Turner, Los Angeles, CA (US)

(21) Appl. No.: 15/727,433

(22) Filed: Oct. 6, 2017

Related U.S. Application Data
(60) Provisional application No. 62/405,030, filed on Oct. 6, 2016.

(51) Int. Cl. A21D 13/50

(52) U.S. Cl. CPC A21D 13/50

(57) ABSTRACT

A pecan lemon meringue pie featuring a variety of all natural ingredients and specially designed to serve as a scrumptious, delicious accent for virtually any meal.

### CLAIM OF PRIORITY

This patent application claims priority under 35 USC 119 (e) (1) from U.S. Provisional Patent Application Ser. No. 62/405,030 filed Oct. 6, 2016, of Edward Turner entitled, “Pecan Lemon Meringue Pie” which is incorporated herein by reference as though the same were set forth in its entirety

### FIELD OF THE INVENTION

The present invention pertains to the field of desserts, and more specifically to the field of a pecan lemon meringue pie featuring a variety of all natural ingredients and specially designed to serve as a scrumptious, delicious accent for virtually any meal.

### BACKGROUND OF THE INVENTION

Dessert is a course that typically comes at the end of a meal, usually consisting of sweet food but sometimes of a strongly-flavored one, such as some cheeses. The word comes from the Old French desservir, “to clear the table.” Some common desserts are cakes, pies, cookies, fruits, pastries, and candies. Some have a separate final sweet course but mix sweet and savory dishes throughout the meal as in Chinese cuisine, or reserve elaborate dessert concoctions for special occasions. Often, the dessert is seen as a separate meal or snack rather than a course, and may be eaten apart from the meal (usually in less formal settings). Some restaurants specialize in dessert. In colloquial American usage “dessert” has a broader meaning and can refer to anything sweet that follows a meal, including milkshakes and other beverages.

The prior art has put forth several designs for meringue desserts. Among these are:

U.S. Pat. No. 2,019,123 to Ernest F. Erickson describes a method of making a meringue composition which consists in heating a mixture of sugar, water and an acid-reacting aerating agent, whipping the heated mixture into whipped egg whites, continuing the whipping until the resultant mixture is firm, preparing a hot starch paste from water and an edible starch, and mixing the hot starch paste with the syrup-egg whites mixture.

U.S. Pat. No. 4,210,679 to Rene Meili describes an improved process is disclosed for the manufacture of a meringue for use in meringue-garnished pastries which will retain its stiffness after whipping. The meringue is formed by whipping a mixture of warm water, boiled gelatine and whipping agents to provide a whipped mixture, adding a boiling solution of xylitol under continued whipping, and thereafter admixing pulverized xylitol under further whipping until a non-collapsing stiffness is attained.

U.S. Pat. No. 2,524,333 to John Alexander Snelling describes a meringue powder comprising essentially a mixture of: finely divided milk powder, a substantial quantity, but not exceeding 9 percent of the total weight of the meringue powder, of a non-injurious strongly electrolytic substantially neutral salt chosen from the group consisting of alkali and alkaline earth metal sulfates and chlorides and mixtures thereof; and adding thereto non-injurious acidic substance in finely divided solid form in an amount to produce a pH value below 7 but not less than 5 in a wet mixture obtained by mixing water with the meringue powder in the proportion of 3 to 10 parts by weight of water to each part by weight of milk powder in the meringue powder.

### SUMMARY OF THE INVENTION

It is an object of the present invention to provide a novel pecan lemon meringue pie featuring a variety of all natural ingredients and specially designed to serve as a scrumptious, delicious accent for virtually any meal.

### BRIEF DESCRIPTION OF THE DRAWINGS

FIG. 1 is a perspective view illustrating a pecan lemon meringue pie, constructed in accordance with the present invention.

FIG. 2 is a perspective view illustrating a slice of the pecan lemon meringue pie of FIG. 1, constructed in accordance with the present invention.

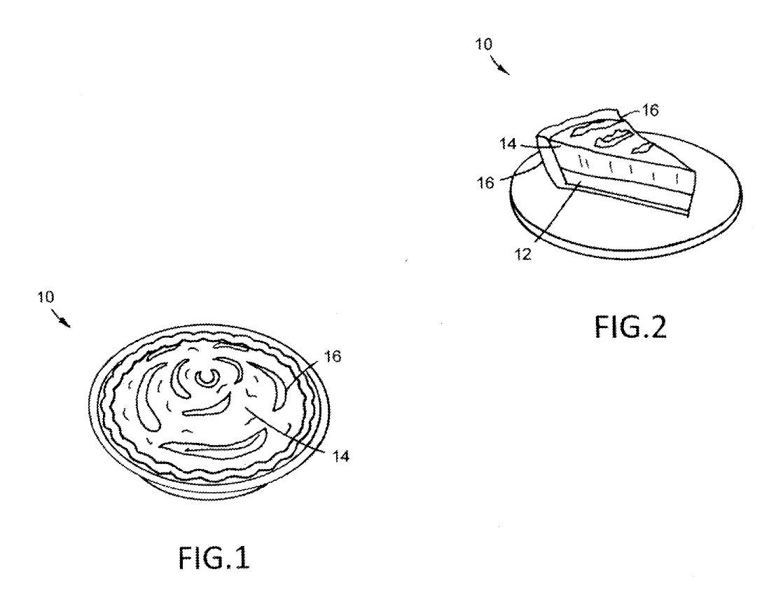

### DETAILED DESCRIPTION OF THE INVENTION

Please refer to the figures. The present invention, hereinafter referred to as a Pecan Lemon Meringue Pie, is a novel dessert. The Pecan Lemon Meringue Pie 10 features a variety of all natural ingredients. Orally ingested, the Pecan Lemon Meringue Pie is specially designed to serve as a scrumptious, delicious accent for virtually any meal.

The Pecan Lemon Meringue Pie is comprised of the following ingredients:
3 eggs at room temperature
½ cup fresh squeezed lemon juice
½ cup chopped pecans
1 teaspoon lemon rind
1 can (14 oz.) sweetened condensed milk
1 graham cracker crust (6″)
¼ teaspoon cream of tartar
¼ cup sugar

To prepare the Pecan Lemon Meringue Pie, the user preheats the oven to 350 degrees F. The sweetened condensed milk is be poured into a bowl, and the lemon juice added and blended with a spoon. Next, the yolk of the eggs is separated from the whites, beaten thoroughly, and folded into the bowl and mixed with the milk and juice. The chopped pecans are then added and mixed, followed by the lemon rind. These preceding steps create the pie mixture 12. The user next beats the egg whites in a separate pan with an electric egg beater until peaked. The cream of tartar is then added and the mixture blended to a stiff, though not dry, consistency, followed by the sugar. These steps create the meringue 14. The previous concoction is poured into the waiting graham cracker crust 16, and the meringue 14 is spread atop the pie mixture 12, sealing the edges completely. The graham cracker crust can consist of crushed graham crackers, butter and sugar. Alternatively, the crust can additionally comprise vanilla extract. In a further alternative embodiment, the graham cracker crust can be purchased frozen. The frozen crust can be allowed to thaw before filling, or alternatively, can be filled and baked while the crust is still frozen. The pie is then placed into the oven for fifteen (15) minutes, or until the meringue is golden brown. The pie is removed from the oven and allowed to cool for 15 minutes, and then be placed into a refrigerator. The Pecan Lemon Meringue Pie can be offered for public sale in an already prepared variety available in a grocer's bakery, or in a pre-made, frozen form available in a food store freezer section.

Use and enjoyment of the Pecan Lemon Meringue Pie is very simple and straightforward. Pulling a pie from the icebox, a young boy can enjoy a slice with a glass of milk as an afterschool snack. Similarly, multiple pies can be incorporated for accentuating a large holiday meal. Regardless of time of day, the Pecan Lemon Meringue Pie provides a fulfilling means of satisfying the most discerning sweet tooth. To best maintain flavor and freshness, any unused portion of this food product should be refrigerated until used again.

There are several significant benefits and advantages associated with this unique product concept. Foremost, the Pecan Lemon Meringue Pie offers users an easily prepared means of enjoying a delicious new dessert item. Whether purchased in an already-prepared form or made from scratch, this product can be ready to eat in a matter of minutes. In this manner, the Pecan Lemon Meringue Pie provides a quick, intriguingly tasteful alternative to many pie varieties. Whether enjoyed in conjunction with a large family meal or simply as a midnight treat, this product proves a palatable contribution to virtually any meal or snack. Nutritious as well as delicious, this product provides the essential vitamins and minerals that are important for maintaining a healthy, balanced diet. Ideal for households, the Pecan Lemon Meringue Pie can also prove an invaluable addition to restaurant menus, perfectly blending with dishes offered by both upscale eateries and corner diners.

The Pecan Lemon Meringue Pie is a clever concept which offers a delightful new food product that serves as an after dinner treat, or even as an appetizer or entree. Featuring savory and tasty food choices with a tart citrus kick, this delicious dish offers a scrumptious new food that appeals to adults and children alike. Affordably priced, the Pecan Lemon Meringue Pie will be well received by the vast majority of households, as well as restaurants and other dining establishments.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A pecan lemon meringue pie comprising a variety of all natural ingredients including:
a) 3 eggs at room temperature;
b) ½ cup fresh squeezed lemon juice;
c) ½ cup chopped pecans;
d) 1 teaspoon lemon rind;
e) 1 can (14 oz.) sweetened condensed milk;
f) 1 graham cracker crust (6″);
g) ¼ teaspoon cream of tartar; and
h) ¼ cup sugar.

2. The pecan lemon meringue pie of claim 1 wherein the ingredients are prepared by a user, wherein:
a) the user preheats an oven to 350 degrees F.;
b) sweetened condensed milk is poured into a bowl, and the lemon juice added and blended with a spoon;
c) eggs are separated and yolk of the eggs is separated from the whites of the eggs, yolks beaten thoroughly, and folded into the mixture in the bowl and mixed with the milk and juice;
d) chopped pecans are then added and mixed;
e) lemon rind is added to create the pie mixture;
f) user beats the egg whites in a separate pan until peaked;
g) cream of tartar is then added and the mixture blended to a stiff, though not dry, consistency;
h) sugar is added to create the meringue;
i) mixture is poured into the graham cracker crust, and the meringue spread on top of the pie mixture, sealing the edges completely to make a pie;
j) the pie is then placed into the oven for fifteen (15) minutes, or until the meringue is golden brown;
k) the pie is removed from the oven and allowed to cool for 15 minutes, and then be placed into a refrigerator.

3. The lemon meringue pie of claim 2, wherein the graham cracker crust comprises crushed graham crackers, sugar and butter.

4. The lemon meringue pie of claim 2, wherein the graham cracker crust comprises crushed graham crackers, sugar, vanilla extract and butter.

5. The lemon meringue pie of claim 2, wherein the graham cracker crust is purchased frozen and allowed to thaw before filling.

6. The lemon meringue pie of claim 2, wherein the graham cracker crust is purchased frozen and is filled and baked while the crust is frozen.

7. The lemon meringue pie of claim 2, wherein the eggs are Grade A, extra large.

8. The lemon meringue pie of claim 2, wherein the eggs are Grade A, jumbo.

9. The lemon meringue pie of claim 2, wherein the eggs are Grade A, large.
